(19) United States
(12) Patent Application Publication
(10) Pub. No.: US 2006/0061609 A1
(43) Pub. Date: Mar. 23, 2006

(54) Droplet ejection head driving method, droplet ejection head and droplet ejection device

(75) Inventors: Masakazu Okuda, Kanagawa (JP); Ryuichi Kojima, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/224,382

(22) Filed: Sep. 12, 2005

(30) Foreign Application Priority Data
Sep. 22, 2004 (JP) 2004-276120

(51) Int. Cl. B41J 29/38

(52) U.S. Cl. 347/10

(57) ABSTRACT

A driving method for a droplet ejection head which is plurally equipped with an ejector, which includes a nozzle and an actuator for ejecting droplets. The driving method includes preparing plural driving waveforms that correspond to variations between respectively differing ejection characteristics of the ejectors, and systematically or arbitrarily applying the plural of driving waveforms to the actuators as driving signals. Accordingly, when a driving waveform which is suited to an ejection characteristic of the head is applied, a normal ejection can be performed. In contrast, when a driving waveform which is not suited to the ejection characteristic of the head is applied, an ejection state is not optimal. However, the driving waveform suited to the ejection characteristic is applied immediately thereafter. The driving waveform not suited to the ejection characteristic is applied to the ejector systematically or arbitrarily, and is not applied continuously.

### CROSS-REFERENCE TO RELATED APPLICATION

This application claims priority under 35 USC 119 from Japanese Patent Application No. 2004-276120, the disclosure of which is incorporated by reference herein.

### BACKGROUND OF THE INVENTION

1. Field of the Invention

The present invention relates to a droplet ejection head driving method, a droplet ejection head and a droplet ejection device, and more particularly relates to a droplet ejection head driving method, droplet ejection head and droplet ejection device using the driving method which eject droplets using actuators such as piezoelectric elements or the like.

2. Description of the Related Art

At a droplet ejection head which uses electromechanical conversion elements, such as piezoactuators (piezoelectric elements) or the like, it is possible to accurately control meniscus operations of a nozzle portion by applying a driving waveform to an electromechanical conversion element. Consequently, high frequency ejections, microdroplet ejections, control of satelliting/misting (smaller droplets which accompany ejected droplets, small droplets which are scattered, and so forth) and the like are possible. It is necessary for the driving waveform applied to the head to be suitably specified in accordance with three conditions: an ejection efficiency of the head; a resonance period (Tc) (Helmholtz resonance period) of pressure waves, which is set by structure of the droplet ejection head and suchlike; and a flow path, which is a form of the nozzle and suchlike.

However, in an actual droplet ejection head, such as an inkjet recording head or the like, because of inconsistencies in fabrication, variations in the above-mentioned three conditions will arise between ejectors corresponding to the nozzles which eject droplets. Consequently, when any particular driving waveform is applied to the droplet ejection head, there will be ejectors to whose characteristics the driving waveform is not suited and at which ejection characteristics are unsatisfactory.

In particular, the natural (resonance) period of pressure waves (Tc) affects not only droplet speeds, droplet volumes and the like, but also greatly affects high-frequency ejection characteristics, states of occurrence of satelliting/misting, and the like. Therefore, when there is an ejector in the droplet ejection head whose natural period Tc does not match the driving waveform, there is a problem in that ejection characteristics of this ejector at high frequencies are adversely affected, which leads to reductions in image quality, reliability, etc.

Accordingly, as methods for addressing the problem described above, technologies are described in, for example, Japanese Patent Application Laid-Open (JP-A) No. 10-235859 and Japanese Patent Application Publication (JP-B) No. 06-077992. In such technologies, driving circuits which are capable of applying respectively optimal driving waveforms to respective ejectors are used. Thus, the problem described above can be dealt.

However, with the technologies described in JP-A No. 10-235859 and JP-B No. 06-077992, while the driving circuits which apply respectively different driving waveforms to respective ejectors are used, costs of such driving circuits are greatly increased, which is a problem.

On the other hand, if inconsistencies in ejector characteristics within a head are reduced, the problem described above does not occur, but fabrication costs of the head are greatly increased. Therefore, this is not practical.

### SUMMARY OF THE INVENTION

The present invention has been devised in order to address the problem described above, and will provide a droplet ejection head driving method, droplet ejection head and droplet ejection device which are capable of suppressing differences between ejections from nozzles at low cost, and of suppressing image quality deterioration.

A first aspect of the present invention provides a driving method for a droplet ejection head which is plurally equipped with an ejector, which includes a nozzle and an actuator for ejecting droplets, the driving method including: preparing a plurality of driving waveforms that correspond to respectively differing ejection characteristics of the ejectors; and at least one of systematically and arbitrarily applying the plurality of driving waveforms to the actuators as driving signals.

According to the first aspect, the plural driving waveforms are prepared in accordance with the respectively differing ejection characteristics of the ejectors. For example, plural driving waveforms corresponding to variations in a resonance period (Helmholtz resonance period) of the droplet ejection head, plural driving waveforms corresponding to variations in ejection efficiency, plural driving waveforms corresponding to variations in flow paths of the droplet ejection head, or the like are prepared. Here, the plural driving waveforms may include ejection characteristics for standard values (for example, design values) of the ejectors.

Hence, the prepared plural driving waveforms can be applied to the actuators systematically or arbitrarily. That is, a driving waveform with suitable ejection characteristics is systematically or arbitrarily applied to an actuator and, also a driving waveform with non-suitable ejection characteristics is systematically or arbitrarily applied to the actuator.

When the driving waveform with suitable ejection characteristics is applied to the actuator, a standard ejection can be performed, and droplet volume, droplet speed and conditions of occurrence of satelliting/misting will be usual. As a result, problems with occurrences of misting, wetting of a nozzle face and the like will not occur.

On the other hand, when the driving waveform with non-suitable ejection characteristics is applied to the actuator, the droplet volume, droplet speed and the like will be slightly shifted from target values, and conditions of occurrence of satelliting/misting will not be in an optimal state. Furthermore, depending on circumstances, misting, wetting of the nozzle face and the like may occur to a greater or lesser extent. However, even though this driving waveform with non-suitable ejection characteristics is applied, the driving waveform with non-suitable characteristics is not applied continuously but applied systematically or arbitrarily. Accordingly, after the driving waveform with non-suitable ejection characteristics has been applied, the driving waveform with suitable ejection characteristics is applied. Therefore, wetting of the nozzle face and the like can be alleviated, serious ejection problems such as non-ejection and the like will not result, and ejection variations can be suppressed. Hence, because the driving waveform(s) with non-suitable ejection characteristics is/are systematically or arbitrarily applied to the actuators, deleterious effects will not be continuously applied to images, and image quality deterioration is suppressed.

That is, the present invention is based on an experimental finding that, with respect to the occurrence of serious ejection problems such as non-ejection and the like at a droplet ejection head, in a case in which a driving waveform which is non-suitable for ejection characteristics of an ejector is repeatedly applied to the ejector, the occurrence of these serious ejection problems can be prevented if a suitable driving waveform is also periodically applied.

Further, because there is no need to implement reductions in inconsistencies of structural components in the head more than necessary, it is possible to suppress variations in ejections from the nozzles in the head at low cost.

Thus, erratic ejections from the nozzles in the head can be suppressed at low cost and image quality deterioration can be suppressed.

If, for example, electromechanical conversion elements are used as actuators for the present aspect, the driving method of the droplet ejection head may apply driving signals to the electromechanical conversion elements and deform the electromechanical conversion elements, thus causing pressure changes in pressure chambers and ejecting liquid loaded into the pressure chambers from the nozzles, which are in fluid communication with the pressure chambers, as droplets. In such a case, the droplet ejection head driving method may include: preparing the plural driving waveforms corresponding to the respectively differing ejection characteristics of the droplet ejection head, including an ejection characteristic with a standard value of the droplet ejection head; and applying the plural driving waveforms to the electromechanical conversion elements systematically or arbitrarily.

A second aspect of the present invention provides a droplet ejection head including: a plurality of ejectors, each ejector including: a pressure chamber into which liquid is loaded; a nozzle in fluid communication with the pressure chamber; an actuator that when a driving signal is applied, causes the liquid loaded at the pressure chamber to be ejected from the nozzle as a droplet; and a driving circuit that applies the driving signal to the actuator, wherein the driving circuit prepares a plurality of driving waveforms that correspond to respectively differing ejection characteristics of the ejectors, and at least one of systematically and arbitrarily applies the plurality of driving waveforms to the actuator as the driving signal.

According to the second aspect, when the driving signal is applied to the actuator, the liquid loaded in the pressure chamber is ejected from the nozzle in the form of a droplet.

At such times, because the driving signal is applied to the actuator by the driving circuit with a droplet ejection head driving method similar to the first aspect, as described above, inconsistent ejections from respective nozzles in the head can be suppressed at low cost and image quality deterioration can be suppressed.

A third aspect of the present invention provides a droplet ejection device including a droplet ejection head that includes a plurality of ejectors, each ejector including: a pressure chamber into which liquid is loaded; a nozzle in fluid communication with the pressure chamber; an actuator that when a driving signal is applied, causes the liquid loaded at the pressure chamber to be ejected from the nozzle as a droplet; and a driving circuit that applies the driving signal to the actuator, wherein the driving circuit prepares a plurality of driving waveforms that correspond to respectively differing ejection characteristics of the ejectors, and at least one of systematically and arbitrarily applies the plurality of driving waveforms to the actuator as the driving signal.

Because the droplet ejection device of the third aspect is equipped with the droplet ejection head of the second aspect, similarly to the second aspect of the invention, inconsistent ejections from respective nozzles in the head can be suppressed at low cost and image quality deterioration can be suppressed.

According to the present invention as described above, plural driving waveforms corresponding with respectively differing ejection characteristics of ejectors are prepared, and the plural driving waveforms are applied to actuators systematically or arbitrarily. Consequently, there are advantages in that variations between ejections from the nozzles in a head are suppressed at low cost and deteriorations in image quality can be suppressed.

### BRIEF DESCRIPTION OF THE DRAWINGS

Embodiments of the present invention will be described in detail based on the following figures, wherein:

FIG. 1 is a view showing an inkjet recording device relating to a first embodiment of the present invention;

FIG. 2 is a view showing structure of an ejector for one nozzle of a head of the inkjet recording device relating to the first embodiment of the present invention;

FIG. 3 is a view showing a driving circuit which drives the head of the inkjet recording device relating to the first embodiment of the present invention;

FIGS. 4A, 4B and 4C are graphs showing examples of driving waveforms which are generated by waveform generation circuits of the first embodiment of the present invention for corresponding with variations in a natural period of the head;

FIG. 5 is a view showing a driving circuit which drives a head of an inkjet recording device relating to a second embodiment of the present invention;

FIGS. 6A, 6B and 6C are graphs showing examples of waveforms which are generated by a waveform generation circuit of the second embodiment of the present invention;

FIGS. 7A, 7B and 7C are graphs showing examples of driving waveforms for corresponding with variations in ejection efficiency;

FIGS. 8A, 8B and 8C are graphs showing examples of driving waveforms for corresponding with variations between flowpaths of ejectors; and

FIGS. 9A, 9B and 9C are graphs showing examples of driving waveforms which are generated by waveform generation circuits of a third embodiment of the present invention.

### DETAILED DESCRIPTION OF THE INVENTION

Herebelow, examples of embodiments of the present invention will be described in detail with reference to the drawings. For the present embodiments, the present invention is applied to an inkjet recording device which serves as a droplet ejection device.

### First Embodiment

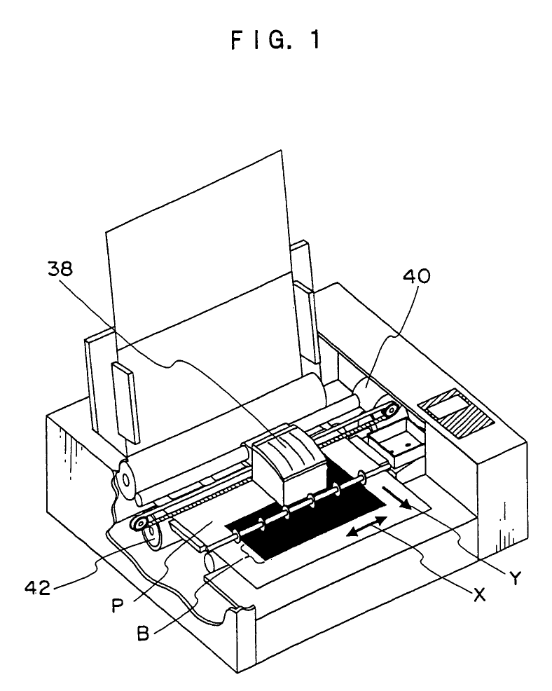

FIG. 1 is a view showing an inkjet recording device relating to a first embodiment of the present invention.

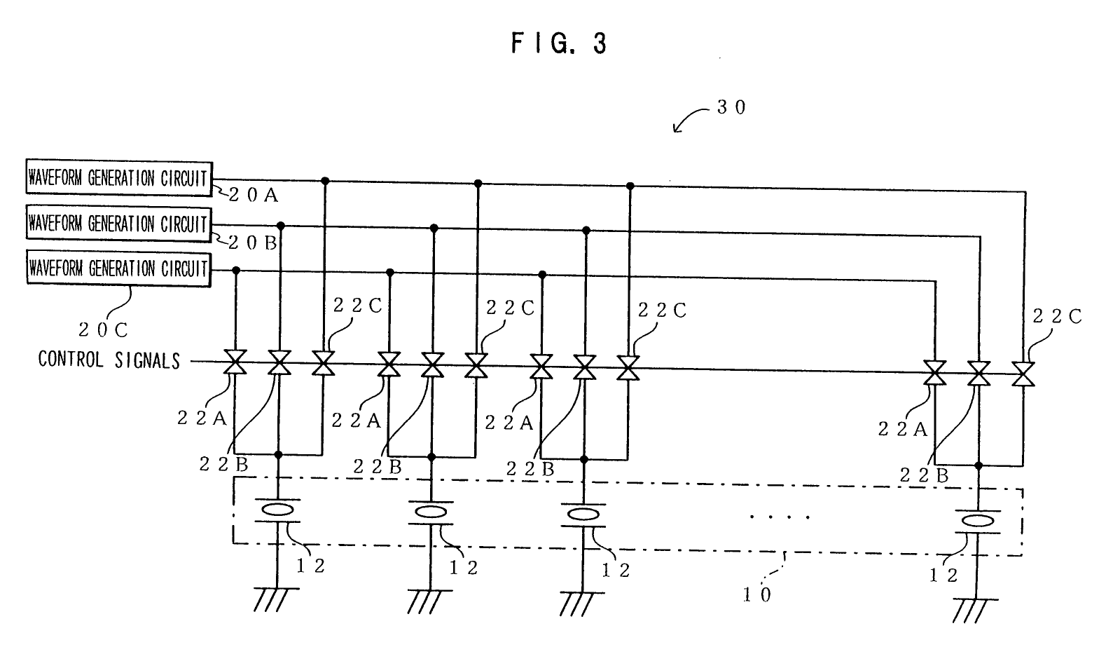

As shown in FIG. 1, the inkjet recording device relating to the first embodiment of the present invention is structured to include a carriage 38, a main scanning mechanism 40 and a sub-scanning mechanism 42. A head 10, which serves as a droplet ejection head of the present invention (see FIG. 3), is loaded at the carriage 38. The main scanning mechanism 40 is for scanning the carriage 38 in a main scanning direction X. The sub-scanning mechanism 42 is for conveying recording paper P, which serves as a recording medium, in a sub-scanning direction Y.

The head 10 is placed on the carriage 38 such that a nozzle face opposes the recording paper P, and ink drops, which serve as droplets, are ejected toward the recording paper P while the head 10 is being conveyed in the main scanning direction X. Thus, recording onto a constant band region B is performed.

Then, the recording paper is conveyed in the sub-scanning direction Y, and a next band region is recorded while the carriage 38 is again being conveyed in the main scanning direction X. An image is recorded over a whole surface of the recording paper P by repeating the above operations.

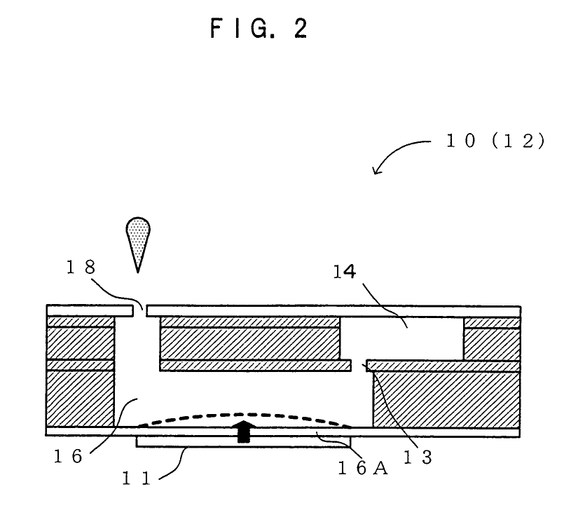

FIG. 2 is a view showing structure of an ejector for one nozzle of the head of the inkjet recording device relating to the first embodiment of the present invention.

The head 10 includes plural ejectors 12, which each include an ink tank 14, a supply channel 13, a pressure chamber 16, a nozzle 18 and a piezoelectric element 11, which serves as an electromechanical conversion element.

Ink is reserved in the ink tank 14. The ink stored in the ink tank 14 is loaded through the supply channel 13 into the pressure chamber 16, and the ink is supplied to the nozzle 18, which communicates with the pressure chamber 16.

A portion of a wall face of the pressure chamber 16 is constituted by a diaphragm 16A. The piezoelectric element 11, which is a piezoelement or the like, is disposed at the diaphragm 16A. The diaphragm 16A is deformed and caused to oscillate by the piezoelectric element 11. As a result, a pressure wave is generated in the pressure chamber 16. Thus, by the pressure wave generated by oscillation of the piezoelectric element 11, ink pooled in the pressure chamber 16 is discharged from the nozzle 18. The ink in the pressure chamber 16 is supplemented from the ink tank 14, via the supply channel 13.

Note that the nozzles 18 could, for example, be plurally arranged in a width direction of the recording paper. In such a case, it is possible to record an image onto the recording paper by recording an image across the width direction of the recording paper and relatively moving the recording paper and the recording head.

FIG. 3 is a view showing a driving circuit which drives the head of the inkjet recording device relating to the first embodiment of the present invention.

As shown in FIG. 3, a driving circuit 30 of the head 10 relating to the present embodiment has a structure in which the plural ejectors 12 are arranged. Each ejector 12 (i.e., the piezoelectric element 11 thereof) is connected to respective one ends of three switching elements 22A, 22B and 22C.

Other ends of the switching elements 22A, 22B and 22C are connected to waveform generation circuits 20A, 20B and 20C, which generate respectively different driving waveforms for driving the ejectors 12.

Herein, the switching elements 22A, 22B and 22C are controlled to be turned on and off by control signals.

Thus, when the switching elements 22A, 22B and 22C are turned on and off by the control signals, the driving waveforms that are applied to the ejectors 12 are switched. When the driving waveforms are applied to the ejectors 12, the piezoelectric elements 11 oscillate and ink droplets are ejected. Here, when one of the three switching elements 22A, 22B and 22C is to be turned on by a control signal, the three switching elements 22A, 22B and 22C turn on and off, systematically or arbitrarily, as a set. For example, control signals which control to turn the switching elements 22A, 22B and 22C on and off in turn or control signals which control to turn the switching elements 22A, 22B and 22C on and off at random are applied to the switching elements 22A, 22B and 22C.

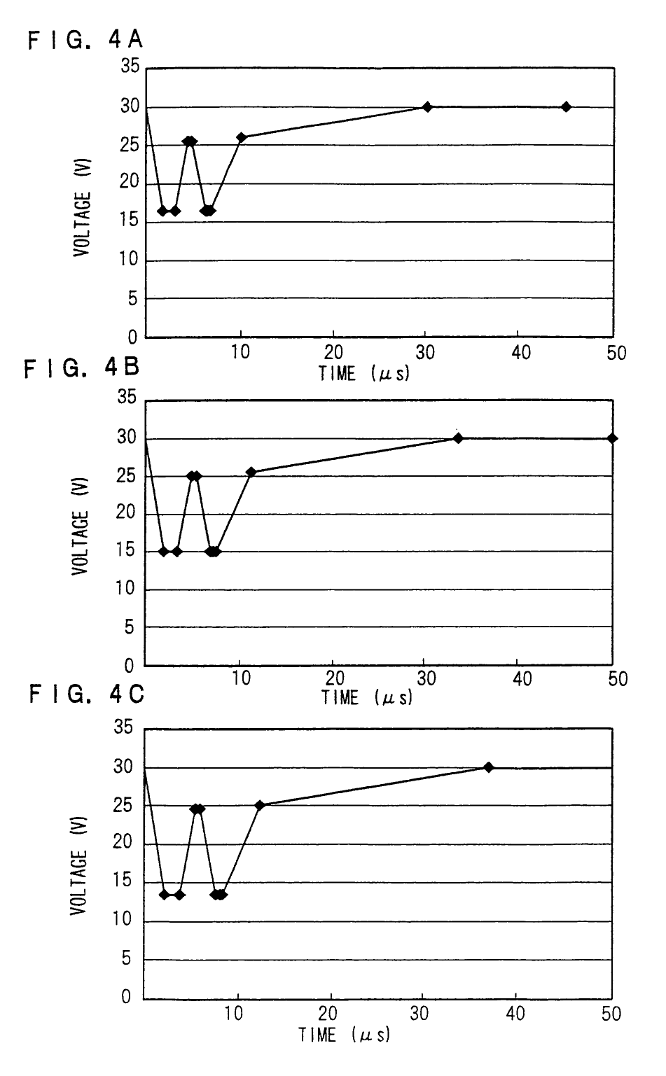

Now, the waveforms generated by the three waveform generation circuits 20A, 20B and 20C will be described in more detail. FIGS. 4A to 4C are graphs showing examples of driving waveforms which are generated by the waveform generation circuits 20A, 20B and 20C of the first embodiment of the present invention.

FIG. 4A shows a driving waveform which is generated by the waveform generation circuit 20A, FIG. 4B shows a driving waveform which is generated by the waveform generation circuit 20B, and FIG. 4C shows a driving waveform which is generated by the waveform generation circuit 20C.

The waveform generation circuits 20A, 20B and 20C generate the driving waveforms of FIGS. 4A to 4C for ejecting microdroplets with overall droplet volumes of around 2 pl. FIG. 4A shows a driving waveform which is designed so as to suit the ejectors 12 of the head 10 that have a natural (resonance) period of 9 μs, FIG. 4B shows a driving waveform which is designed so as to suit the ejectors 12 of the head 10 that have a natural period of 10 μs, and FIG. 4C shows a driving waveform which is designed so as to suit the ejectors 12 of the head 10 that have a natural period of 11 μs.

In the present embodiment, the head 10 which is used is designed with a middle value (a standard value) of natural periods of the head 10 of 10 μs. However, there will be variations from 9 to 11 μs due to inconsistencies of fabrication. In other words, the waveform generation circuits 20A, 20B and 20C generate driving waveforms such that the generated driving waveforms correspond to variations which include a design value of the natural period.

More specifically, with the driving waveform of FIG. 4B (the design value) serving as a middle value, the waveform generation circuits 20A and 20C generate driving waveforms in which that driving waveform is stretched/compressed in a time-axis direction and in a voltage axis direction, so as to make the driving waveforms correspond to the variations between natural periods of the head 10.

Next, operations of the inkjet recording device relating to the first embodiment of the present invention, which is structured as described above, will be described.

As mentioned above, the three waveform generation circuits 20A, 20B and 20C are provided at the driving circuit 30 of the inkjet recording device relating to the first embodiment of the present invention, and generate driving waveforms to correspond with variations in natural period of the head 10. The driving waveforms generated by the waveform generation circuits 20A, 20B and 20C are systematically or arbitrarily applied to the ejectors 12 by control signals during recording of an image.

Now, one of the ejectors 12, which has the middle value (10 μs) of natural periods of the head 10 will be considered. The driving waveforms of FIGS. 4A to 4C are systematically or arbitrarily applied at this ejector 12. When, for example, the driving waveform shown in FIG. 4B is applied, because this driving waveform is suited to the natural period of the head 10, a usual ejection can be performed, and droplet volumes, droplet speeds and conditions of occurrence of satelliting/misting are usual. Consequently, misting, wetting of the nozzle face and the like do not occur.

On the other hand, when the driving waveform shown in FIG. 4A or 4C is applied, droplet volumes, droplet speeds and the like are slightly shifted from target values, and conditions of occurrence of satelliting/misting are not in an optimal state. Furthermore, depending on circumstances, misting, wetting of the nozzle face and suchlike may occur to some extent. However, even when these driving waveforms which are not suited to characteristics of the ejector 12 are applied, these non-suitable driving waveforms are not continuously applied. Rather, after the non-suitable driving waveforms have been applied, the driving waveform of FIG. 4B which is suited to characteristics of the ejector 12 is applied. Consequently, wetting of the nozzle face and suchlike are alleviated, a serious ejection failure, such as non-ejection or the like, will not result, and variations in ejection can be suppressed. That is, because the driving waveforms which are not suited to ejection characteristics of the ejector 12 are applied to the ejector 12 systematically or arbitrarily, deleterious effects are not continuously exerted on image quality, and image quality deterioration can be suppressed.

Next, an ejector at which the natural period of the head 10 is 9 μs, which is offset from the middle value, will be considered. At this ejector 12, when the driving waveforms of FIGS. 4B and 4C are applied, ejection characteristics are poorer. However, because the driving waveform of 4A, which is suited to characteristics of this ejector 12 is applied as described above, serious ejection problems will not result, and variations in ejection can be suppressed. Thus, because the driving waveforms which are not suited to ejection characteristics of this ejector 12 are systematically or arbitrarily applied to the ejector 12, adverse effects are not continuously exerted on image quality, and image quality deterioration can be suppressed.

That is, when there are differences between natural periods, conventionally, only a driving waveform corresponding to a middle value of the natural periods would be applied. As a result, ejection problems would be continuous at ejectors which were offset from the middle value, leading to serious ejection problems such as non-ejection and the like. In contrast, in the present embodiment, rather than a single waveform which is not suited to certain characteristics, driving waveforms which suit the characteristics are systematically or arbitrarily applied. Therefore, serious ejection problems such as non-ejection and the like can be avoided.

Accordingly, plural driving waveforms corresponding to inconsistencies in natural period within the head 10 are prepared, and these waveforms are systematically or arbitrarily applied to the ejectors 12. Consequently, occurrences of serious ejection problems are prevented, inconsistencies in ejection can be suppressed, and image quality and reliability can be greatly improved.

### Second Embodiment

Next, an inkjet recording device relating to a second embodiment of the present invention will be described. Here, the structure of the inkjet recording device and ejector structures are the same as in the first embodiment. Accordingly, descriptions thereof are omitted.

In the first embodiment, the plural waveform generation circuits 20A, 20B and 20C are provided, and the driving waveforms generated by the waveform generation circuits 20A, 20B and 20C are periodically or arbitrarily applied to the ejectors 12 by switching operations with control signals. In the second embodiment however, the above-described plural driving waveforms are generated in a time series by a single waveform generation circuit, and are applied to the ejectors 12 by time-slicing (time-divisioning). That is, only the driving circuit is different, while the structure of the inkjet recording device, the structures of the ejectors of the head and the like are the same as in the first embodiment. Accordingly, descriptions thereof are omitted.

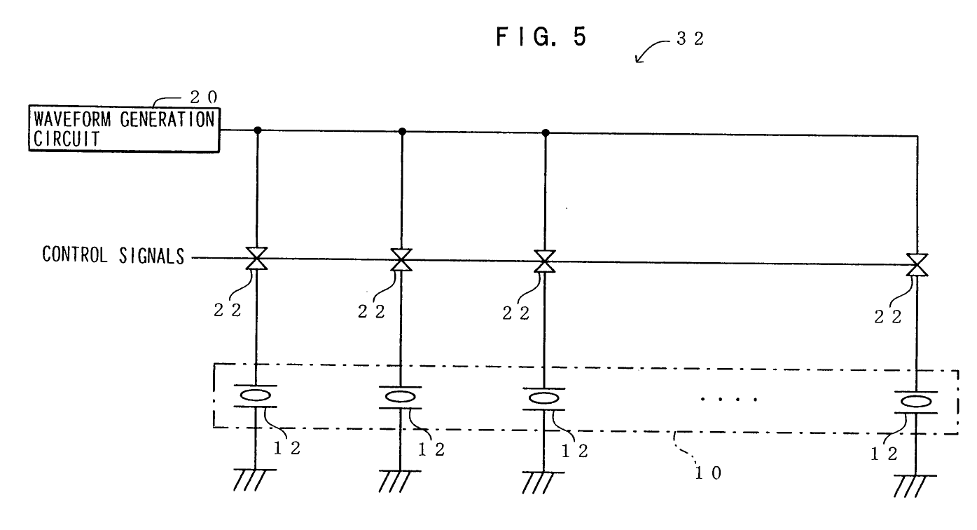

FIG. 5 is a view showing a driving circuit which drives the head of the inkjet recording device relating to the second embodiment of the present invention.

As shown in FIG. 5, a driving circuit 32 of the head 10 relating to the second embodiment has a structure in which the plural ejectors 12 are arranged. Each ejector 12 (i.e. the piezoelectric element 11 thereof) is connected to one end of a respective switching element 22.

Another end of the switching element 22 is connected to a waveform generation circuit 20, which generates a driving waveform for driving the ejectors 12.

The switching elements 22 are controlled to be turned on and off by control signals.

Thus, the driving waveform that is generated by the waveform generation circuit 20 is applied to the ejectors 12 by the switching elements 22 being turned on and off by the control signals. When the driving waveform is applied to the ejectors 12, the piezoelectric elements 11 oscillate and ink droplets are ejected. Here, driving waveforms to be applied to the ejectors 12 are switched in accordance with timings at which the switching elements 22 are turned on and off, and respective driving waveforms are systematically or arbitrarily applied.

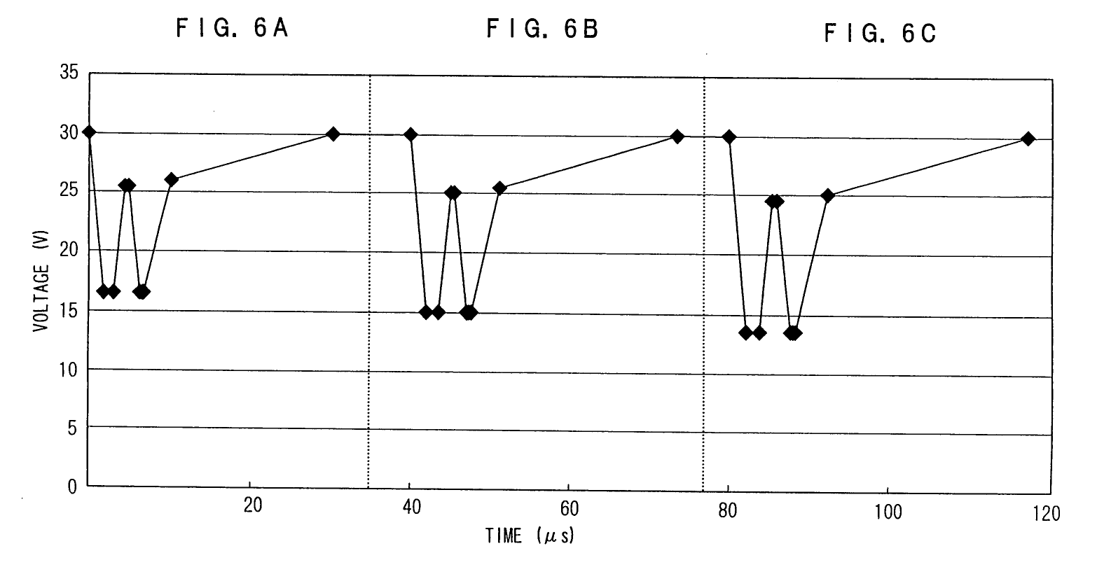

Now, the waveforms generated by the waveform generation circuit 20 of the present embodiment will be described in more detail. FIGS. 6A to 6C are graphs showing examples of waveforms which are generated by the waveform generation circuit 20 of the second embodiment of the present invention.

At the waveform generation circuit 20 of the present embodiment, the driving waveforms corresponding to variations in the natural period of the head 10, as illustrated in FIGS. 4A to 4C for the first embodiment, are generated in the form of a single driving waveform in which these driving waveforms are generated in a time series, as shown in FIGS. 6A to 6C.

In the example of FIGS. 6A to 6C, the waveform generation circuit 20 of the present embodiment first generates the driving waveform of FIG. 4A, next generates the driving waveform shown in FIG. 4B, and then generates the driving waveform shown in FIG. 4C, in turn.

Thus, it is possible to switch the driving waveforms to be applied by switching the switching elements 22 for time divisions and, similarly to the first embodiment, the plural driving waveforms can be applied to the ejectors 12 periodically or arbitrarily.

Now, in the present embodiment, because the driving waveforms applied to the ejectors 12 are switched by time division operations, there is a possibility that recording timings will be shifted and that impact positions will be shifted. However, this would occur at a level which is effectively harmless compared to the occurrence of non-ejecting nozzles.

Next, operations of the inkjet recording device relating to the second embodiment of the present invention, which is structured as described above, will be described.

At the driving circuit 32 of the inkjet recording device relating to the second embodiment of the present invention, the driving waveforms corresponding to variations in natural periods of the head 10 are generated in the time series by the waveform generation circuit 20.

Hence, the driving waveform generated by the waveform generation circuit 20 is applied to the ejectors 12 systematically or arbitrarily by the control signals. Here, because the plural types of driving waveform are generated in the time series in the driving waveform from the waveform generation circuit 20, each of the plural driving waveforms is applied to the ejectors 12 by time division operations.

Now, one of the ejectors 12, which has the middle value (10 μs) of natural periods of the head 10 will be considered. At this ejector 12, if the switching element 22 is set on at a time of FIG. 6B, a driving waveform suited to the natural period of the head 10 is applied. Thus, a usual ejection can be performed, and droplet volumes, droplet speeds and conditions of occurrence of satelliting/misting are usual. Consequently, misting, wetting of the nozzle face and the like do not occur.

Alternatively, if the switching element 22 is set on at a time of FIG. 6A or 6C, a driving waveform which is shifted from a natural period of the head 10 is applied. Thus, droplet volumes, droplet speeds and the like are slightly shifted from target values, and conditions of occurrence of satelliting/misting are not in an optimal state. Furthermore, depending on circumstances, misting, wetting of the nozzle face and suchlike may occur to some extent. However, even when these driving waveforms which are not suited to characteristics of the ejector 12 are applied, similarly to the first embodiment, the driving waveform of the time of FIG. 6B, which is suited to characteristics of the ejector 12, is applied promptly thereafter. Consequently, wetting of the nozzle face and suchlike are alleviated, a serious ejection failure, such as non-ejection or the like, will not result, and variations in ejection can be suppressed. That is, because the driving waveforms which are not suited to ejection characteristics of the ejector 12 are applied to the ejector 12 systematically or arbitrarily, deleterious effects are not continuously exerted on image quality, and image quality deterioration can be suppressed.

Accordingly, in the present embodiment, the plural driving waveforms corresponding to differences between natural periods of the ejectors 12 in the head 10 are generated along the time-axis direction, and the driving waveforms of the times of FIGS. 6A, 6B and 6C are systematically or arbitrarily applied by time division operations. As a result, similarly to the first embodiment, even when there are variations in natural periods of from 9 to 11 μs at the ejectors 12 in the head 10, suitable driving waveforms are systematically or arbitrarily applied to all of the ejectors 12. In consequence, serious ejection problems are prevented, inconsistencies in ejection can be suppressed, and stable ejection can be realized.

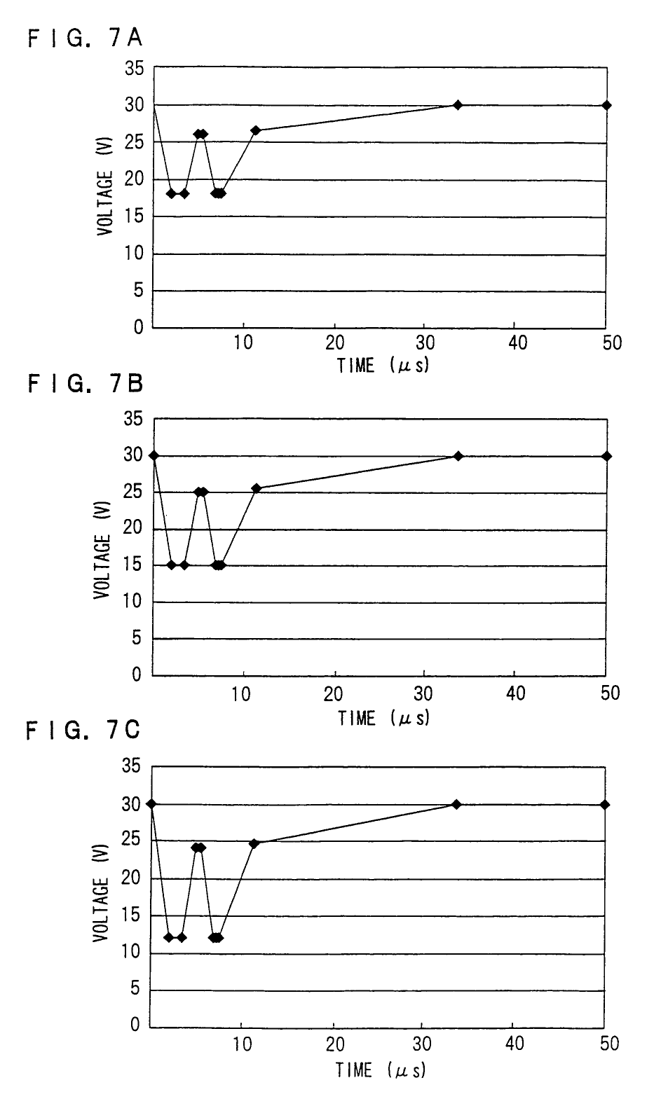

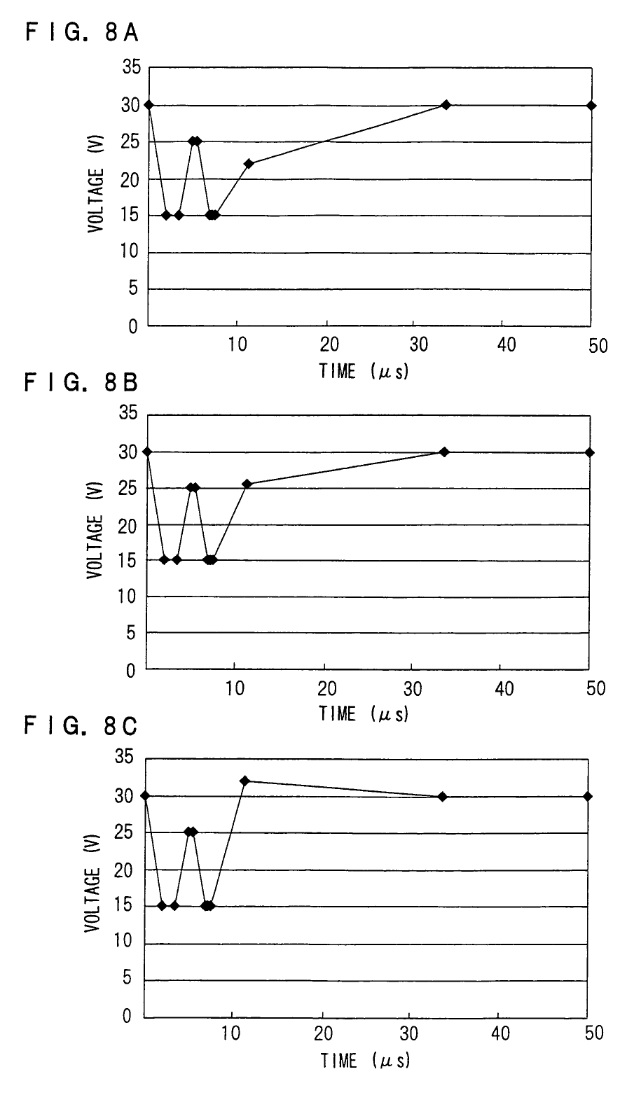

Herein, examples of driving waveforms corresponding to variations in natural periods of the ejectors 12 in the head 10 have been described with the waveforms generated by the plural waveform generation circuits 20A, 20B and 20C of the first embodiment and the driving waveform generated in a time series by the waveform generation circuit 20 of the second embodiment. However, the present invention is not limited thus. For example, as shown in FIGS. 7A to 7C, driving waveforms which correspond to variations in ejection efficiency may be used and, as shown in FIGS. 8A to 8C, driving waveforms which correspond to variations in flow paths of the ejectors 12 may be used.

For example, in FIGS. 7A to 7C, in order to accord with differences between ejection efficiencies, driving waveforms are compressed only in the voltage axis direction, and in FIGS. 8A to 8C, in order to accord with differences between flow paths of the ejectors 12, the driving waveforms are varied in a reverberation suppression portion of the driving waveform, which affects reverberation suppression. With the first embodiment, such driving waveforms would be generated by the waveform generation circuits 20A, 20B and 20C, and with the second embodiment, such driving waveforms would be generated in a time series by the waveform generation circuit 20. Thus, it is possible to respond to inconsistencies in ejection efficiency and inconsistencies in flow paths of the ejectors 12.

Further, although driving waveforms for responding to variations in natural periods of the head 10 are prepared in the first and second embodiments, this is not a limitation. Driving waveforms which correspond to a combination of variations in natural periods of the ejectors 12 in the head 10, variations in ejection efficiency and variations in flow paths may be used.

### Third Embodiment

Next, an inkjet recording device relating to a third embodiment of the present invention will be described. Here, the structure of the inkjet recording device and ejector structures are the same as in the first embodiment. Accordingly, descriptions thereof are omitted.

For the first and second embodiments, a case of ejecting one category of droplet diameter has been described. For the third embodiment however, a case of ejecting three categories of droplet diameter will be described.

A driving circuit of the third embodiment has basically the same structure as the driving circuit of the first embodiment. Accordingly, the driving circuit of the third embodiment will be described with reference to the driving circuit of the first embodiment (see FIG. 3).

In the driving circuit of the third embodiment, the waveform generation circuits 20A, 20B and 20C of the driving circuit of the first embodiment each generates plural driving waveforms in a time series, as at the waveform generation circuit 20 of the second embodiment. In addition, the driving waveforms generated by the waveform generation circuits 20A, 20B and 20C are specified as driving waveforms for ejecting droplets with different droplet volumes. Specifically, the waveform generation circuits 20A, 20B and 20C generate driving waveforms for ejecting ‘large’ droplets, ‘medium’ droplets and ‘small’ droplets, respectively.

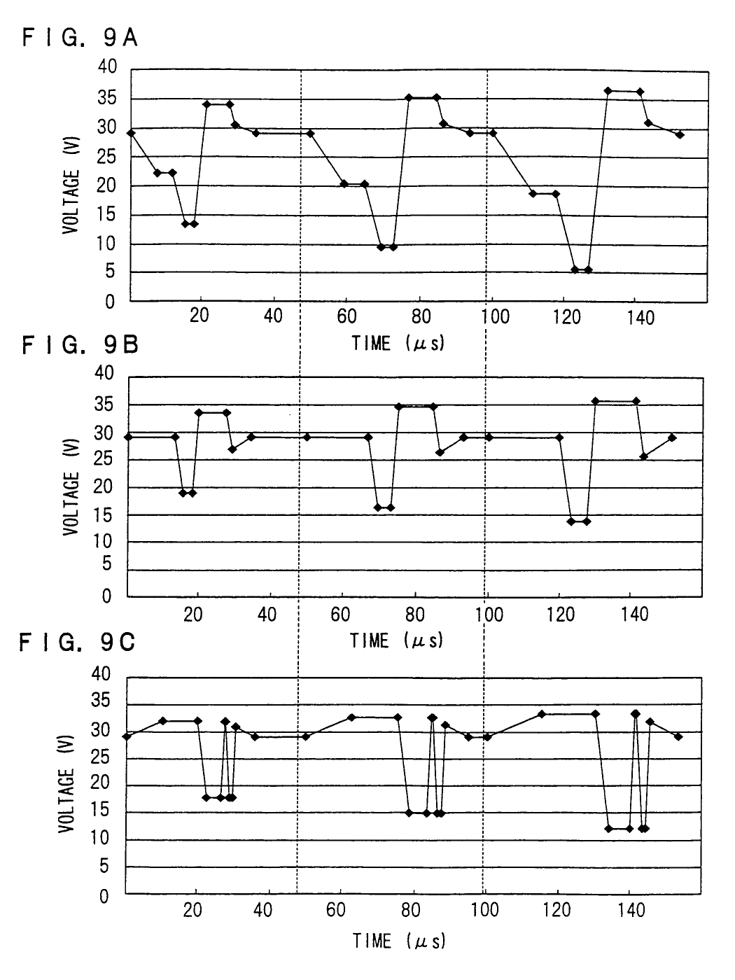

More specifically, for each of the driving waveforms generated by the waveform generation circuits 20A, 20B and 20C, as shown in FIGS. 9A to 9C, plural driving waveforms corresponding to variations in natural periods of the ejectors 12 in the head 10 are generated.

FIG. 9A shows an example in which plural driving waveforms are generated in a time series, which driving waveforms are, in order: a driving waveform for ejecting large droplets which is designed so as to suit the ejectors 12 of the head 10 at which the natural period is 9 μs; a driving waveform for ejecting large droplets which is designed so as to suit the ejectors 12 of the head 10 at which the natural period is 10 μs; and a driving waveform for ejecting large droplets which is designed so as to suit the ejectors 12 of the head 10 at which the natural period is 11 μs. FIG. 9B shows an example in which plural driving waveforms are generated in a time series, which driving waveforms are, in order: a driving waveform for ejecting medium droplets which is designed so as to suit the ejectors 12 of the head 10 at which the natural period is 9 μs; a driving waveform for ejecting medium droplets which is designed so as to suit the ejectors 12 of the head 10 at which the natural period is 10 μs; and a driving waveform for ejecting medium droplets which is designed so as to suit the ejectors 12 of the head 10 at which the natural period is 11 μs. FIG. 9C shows an example in which plural driving waveforms are generated in a time series, which driving waveforms are, in order: a driving waveform for ejecting small droplets which is designed so as to suit the ejectors 12 of the head 10 at which the natural period is 9 μs; a driving waveform for ejecting small droplets which is designed so as to suit the ejectors 12 of the head 10 at which the natural period is 10 μs; and a driving waveform for ejecting small droplets which is designed so as to suit the ejectors 12 of the head 10 at which the natural period is 11 μs.

Next, operations of the inkjet recording device relating to the third embodiment of the present invention, which is structured as described above, will be described.

At the inkjet recording device relating to the third embodiment, the three waveform generation circuits 20A, 20B and 20C are provided. By selecting from the driving waveforms generated by the waveform generation circuits 20A, 20B and 20C, it is possible to implement adjustment of droplet diameters. Further, similarly to the waveform generation circuit 20 of the second embodiment, the waveform generation circuits 20A, 20B and 20C generate pluralities of driving waveforms corresponding to variations in natural periods of the ejectors 12 in the head 10 in time series.

That is, the switching element which is to be turned on is selected from among the switching elements 22A, 22B and 22C by control signals. Thus, it is possible to alter droplet diameters of the droplets that are ejected.

Further, the control signals are regulated so as to match a timing at which the selected one of the switching elements 22A, 22B and 22C is turned on with one or other of the plural driving waveforms generated in the corresponding time series. As a result, similarly to the second embodiment, it is possible to systematically or arbitrarily, by time division operations, apply the driving waveforms to the ejectors 12 to accord with differences between natural periods of the ejectors 12.

Therefore, similarly to the first and second embodiments, even when there are variations in natural periods of from 9 to 11 μs at the ejectors 12 in the head 10, driving waveforms which are suited to characteristics of the ejectors 12 are systematically or arbitrarily applied to all of the ejectors 12. In consequence, serious ejection problems are prevented, inconsistencies in ejection can be suppressed, and stable ejection can be realized.

In the third embodiment too, driving waveforms which correspond to variations in ejection efficiencies, as shown in FIGS. 7A to 7C, may be applied and driving waveforms which correspond to variations in flow paths of the ejectors 12, as shown in FIGS. 8A to 8C, may be applied. Driving waveforms which correspond to a combination of variations in natural periods of the ejectors 12, variations in ejection efficiency and variations in flow paths of the ejectors 12 could also be used.

As has been described for the above embodiments, in the present invention, the plural driving waveforms may include a driving waveform which is one of stretched or compressed in a voltage direction relative to a driving waveform corresponding to an ejection characteristic with a standard value of the ejectors. By contracting driving waveforms in the voltage-axis direction, it is possible to generate driving waveforms which correspond to variations in ejection efficiency of the droplet ejection head, and it is possible to suppress inconsistencies of ejection efficiency of the droplet ejection head.

Further, the plural driving waveforms may include a driving waveform which is one of stretched or compressed in a time-axis direction relative to the driving waveform corresponding to the ejection characteristic with the standard value of the ejectors. By structuring in such a manner, it is possible to generate driving waveforms which correspond to variations in natural periods of the droplet ejection head, and it is possible to suppress inconsistencies in ejection due to differences between the natural periods of the droplet ejection head.

Further, the plural driving waveforms may include a driving waveform of which a reverberation suppression portion, for suppressing reverberation, is altered relative to a driving waveform corresponding to an ejection characteristic with a standard value of the ejectors. By forming driving waveforms in which the reverberation suppression portion is varied, it is possible to generate driving waveforms which correspond to variations in flow paths of the droplet ejection head, and it is possible to suppress inconsistencies in ejection due to differences between characteristics (such as a rate of attenuation of pressure waves and so forth) of the flow paths of the droplet ejection head.

The plural driving waveforms may be generated by respectively separate waveform generation circuits, and the driving waveforms to be applied can be switched by switching operations. The plural driving waveforms may also be generated in a time series by a single waveform generation circuit and driving waveforms to be applied can be switched by time division operations.

Further, the plural driving waveforms may be respectively prepared for respective driving signals for ejecting droplets with different droplet volumes.

Further again, the actuators that are used may include piezoelectric elements.

For the embodiments described above, examples have been described in which piezoelectric elements are used as actuators for ejecting ink droplets, which serve as droplets. However, the present invention is not limited thus, and other actuators could be used. For example, electromechanical conversion elements which utilize electrostatic force, magnetic force or the like, electrothermal conversion elements which utilize boiling effects to generate pressure forces, and the like, and other pressure generation means may just as well be used. Furthermore, as the piezoelectric actuators, beside the piezoelectric elements of a single plate-type which are used in the present embodiments, multi-layer type piezoelectric actuators of the longitudinal vibration type, and the like, and other forms of actuator may just as well be used.

Moreover, for the embodiments described above, examples of inkjet recording devices which perform recording of text, images and the like by discharging colored ink onto recording paper have been considered. However, the droplet ejection device of the present specification is not limited thus. That is, the recording medium need not be limited to papers, and the droplets that are ejected need not be limited to colored inks. The present invention can be utilized for general droplet jetting devices which are used in industry, such as, for example, fabricating color filters for displays by ejecting colored inks onto polymer films, glass and the like, forming bumps for mounting of components by ejecting molten solder onto substrates, and so forth.

What is claimed is:

1. A driving method for a droplet ejection head which is plurally equipped with an ejector, which includes a nozzle and an actuator for ejecting droplets, the driving method comprising:
preparing a plurality of driving waveforms that correspond to respectively differing ejection characteristics of the ejectors; and
at least one of systematically and arbitrarily applying the plurality of driving waveforms to the actuators as driving signals.

2. The droplet ejection head driving method of claim 1, wherein the plurality of driving waveforms includes a driving waveform corresponding to an ejection characteristic with a standard value of the ejectors.

3. The droplet ejection head driving method of claim 1, wherein the plurality of driving waveforms includes a driving waveform which is one of stretched or compressed in a voltage direction relative to a driving waveform corresponding to an ejection characteristic with a standard value of the ejectors.

4. The droplet ejection head driving method of claim 3, wherein the plurality of driving waveforms includes a driving waveform which is one of stretched or compressed in a time-axis direction relative to the driving waveform corresponding to the ejection characteristic with the standard value of the ejectors.

5. The droplet ejection head driving method of claim 1, wherein the plurality of driving waveforms includes a driving waveform of which a reverberation suppression portion, for suppressing reverberation, is altered relative to a driving waveform corresponding to an ejection characteristic with a standard value of the ejectors.

6. The droplet ejection head driving method of claim 1, wherein the plurality of driving waveforms are generated by respectively separate waveform generation circuits, and the driving waveforms to be applied are switched by switching operations of the waveform generation circuits.

7. The droplet ejection head driving method of claim 1, wherein the plurality of driving waveforms are generated in a time series by a single waveform generation circuit, and the driving waveforms to be applied are switched by time division operations of the waveform generation circuit.

8. The droplet ejection head driving method of claim 1, wherein the plurality of driving waveforms are respectively prepared for respective driving signals for ejecting droplets with different droplet volumes.

9. The droplet ejection head driving method of claim 1, wherein the actuator comprises a piezoelectric element.

10. A droplet ejection head comprising:
a plurality of ejectors, each ejector including:
a pressure chamber into which liquid is loaded;
a nozzle in fluid communication with the pressure chamber;
an actuator that when a driving signal is applied, causes the liquid loaded at the pressure chamber to be ejected from the nozzle as a droplet; and
a driving circuit that applies the driving signal to the actuator, wherein the driving circuit
prepares a plurality of driving waveforms that correspond to respectively differing ejection characteristics of the ejectors, and
at least one of systematically and arbitrarily applies the plurality of driving waveforms to the actuator as the driving signal.

11. The droplet ejection head of claim 10, wherein the plurality of driving waveforms includes a driving waveform corresponding to an ejection characteristic with a standard value of the ejectors.

12. The droplet ejection head of claim 10, wherein the plurality of driving waveforms includes a driving waveform whose form is altered, relative to a driving waveform corresponding to an ejection characteristic with a standard value of the ejectors, in accordance with ejection differences of the ejectors.

13. The droplet ejection head of claim 12, wherein the altered driving waveform includes at least one of a form which is one of stretched or compressed in a voltage direction, a form which is one of stretched or compressed in a time-axis direction and a form of which a reverberation suppression portion is altered, respectively relative to the driving waveform corresponding to the ejection characteristic with the standard value of the ejectors.

14. The droplet ejection head of claim 10, wherein the driving circuit includes a plurality of waveform generation circuits, which generate the plurality of driving waveforms respectively separately, and the driving waveforms to be applied are switched by switching operations of the driving circuit.

15. The droplet ejection head of claim 10, wherein the driving circuit includes a single waveform generation circuit, the single waveform generation circuit generates the plurality of driving waveforms in a time series, and the driving waveforms to be applied are switched by time division operations of the driving circuit.

16. The droplet ejection head of claim 10, wherein the actuator comprises a piezoelectric element.

17. A droplet ejection device comprising:
a droplet ejection head that includes a plurality of ejectors, each ejector including:
a pressure chamber into which liquid is loaded;
a nozzle in fluid communication with the pressure chamber;
an actuator that when a driving signal is applied, causes the liquid loaded at the pressure chamber to be ejected from the nozzle as a droplet; and
a driving circuit that applies the driving signal to the actuator, wherein the driving circuit
prepares a plurality of driving waveforms that correspond to respectively differing ejection characteristics of the ejectors, and
at least one of systematically and arbitrarily applies the plurality of driving waveforms to the actuator as the driving signal.

18. The droplet ejection device of claim 17, wherein the driving circuit includes a plurality of waveform generation circuits, which generate the plurality of driving waveforms respectively separately, and the driving waveforms to be applied are switched by switching operations of the driving circuit.

19. The droplet ejection device of claim 17, wherein the driving circuit includes a single waveform generation circuit, the single waveform generation circuit generates the plurality of driving waveforms in a time series, and the driving waveforms to be applied are switched by time division operations of the driving circuit.

20. The droplet ejection device of claim 17, wherein the droplet ejection device comprises an inkjet recording device which ejects ink onto a recording medium for implementing recording of an image, and the inkjet recording device includes:
a carriage, at which the droplet ejection head is loaded;
a main scanning mechanism, for scanning the carriage in a main scanning direction; and
a sub-scanning mechanism, for conveying the recording medium in a sub-scanning direction.
